(19) United States
(12) Patent Application Publication
(10) Pub. No.: US 2006/0202942 A1
(43) Pub. Date: Sep. 14, 2006

(54) Mirrored LCD display

(75) Inventor: David Fong, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/075,924

(22) Filed: Mar. 9, 2005

(51) Int. Cl. G09G 3/36

(52) U.S. Cl. 345/102

(57) ABSTRACT

A mirrored liquid crystal display (LCD) is provided. One embodiment, among others, comprises a liquid crystal display (LCD); and logic for controlling the LCD to selectively operate in one of two alternative states. The two states include a first state in which the LCD operates in a conventional manner to display visible data to a user, and a second state in which the LCD effectively functions as a mirror.

### FIELD OF THE INVENTION

The present invention relates to a display for a wireless phone or other consumer electronic item.

### BACKGROUND

Wireless phones, also known as cellular phones or mobile phones, have become a common consumer electronics item. While wireless phones were once limited to placing and receiving voice calls, more and more features are being integrated into the wireless phone. Most wireless phones include a contact list, a calculator, an alarm clock, and simplified video games, and many include a digital camera. More advanced models include the features of a personal digital assistant (PDA), such as an address book, a calendar, and a scheduler. Other commonly integrated features include email, web browsing, and instant-messaging. Wireless phones are also getting smaller in size, so that users carry them everywhere. Thus, the wireless phone is fast becoming an indispensable item for both men and women. It is therefore desirable to add even more features to a wireless phone.

### SUMMARY

A mirrored liquid crystal display (LCD) is provided. One embodiment, among others, comprises: a liquid crystal display (LCD); and logic for controlling the LCD to selectively operate in one of two alternative states. The two states include a first state in which the LCD operates in a conventional manner to display visible data to a user, and a second state in which the LCD effectively functions as a mirror.

### DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 is a block diagram of a wireless phone utilizing a mirrored display.

FIG. 2 is a diagram illustrating various modes in which embodiment of the mirrored display can operate in.

FIG. 3 is a perspective view of the mirrored display of FIG. 1.

FIG. 4 is a side view of the internal structure of one embodiment of the mirrored display of FIG. 1.

FIG. 5A is a side view of the internal structure of the mirrored display of FIG. 1, showing how the display appears to the user when the backlight is at maximum output.

FIG. 5B is a side view of the internal structure of the mirrored display of FIG. 1, showing how the display appears to the user when the backlight is off.

FIG. 5C is a side view of the internal structure of the mirrored display of FIG. 1, showing how the display appears to the user when the backlight produces minimal output.

FIG. 6 is a side view of the internal structure of another embodiment of the mirrored display of FIG. 1.

FIG. 7 is a diagram showing a telephephone constructed in accordance with an embodiment of the invention.

### DETAILED DESCRIPTION

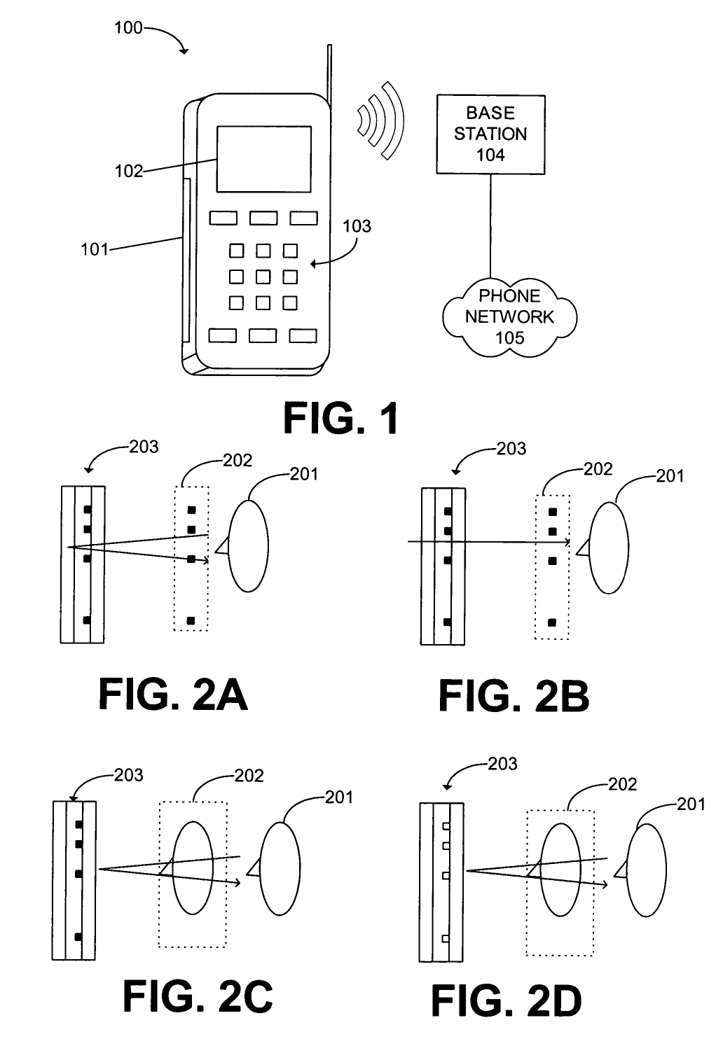

FIG. 1 is a block diagram of a wireless phone utilizing a mirrored display. The phone 100 includes communication logic 101, mirrored display 102 and input logic 103. Communication logic 101 allows phone 100 to communicate over a wireless channel with base station 104. Base station 104 is in communication with a telephone network 105. Thus, phone 100 allows a user to place a call to users via the telephone network 105, or receive a call from users via the telephone network 105. Input logic 103 and mirrored display 102 function as the user interface for phone 100. Through input logic 103, a user operates phone 100, for example, placing and receiving calls, interacting with a contact list or address book, configuring features like ring tones, etc.

Mirrored display 102 operates in two modes. In “normal display” mode, the mirrored display 102 functions as the user interface: it allows a user to see his input, and to view status and settings information. In “mirror” mode, the display becomes reflective, so that data normally viewable in “normal display” mode is not visible, and the user sees instead a reflection. Input logic 103 allows a user to switch between the two modes. In this example the mirrored display 102 and input logic 103 are located on the same side of the phone, but in another embodiment mirrored display 102 and input logic 103 are on different sides.

FIG. 2 is a diagram illustrating various modes which mirrored display 102 can operate in. FIGS. 2A and 2B illustrate normal mode for two different embodiments of mirrored display 102. In both embodiments, the optical characteristics of LCD module 203 are manipulated so that portions of LCD module 203 are substantially transparent, and other portions are substantially opaque, thus conveying data to a viewer 201. In normal mode, image 202 seen by viewer 201 consists of whatever data is displayed by LCD module 203. The embodiment of FIG. 2A uses a reflective LCD module 203, so that image 202 is formed mostly by light passing through LCD module 203 and then reflected back out. The embodiment of FIG. 2B uses a transmissive LCD module 203, so that image 202 is mostly formed by light emanating from behind LCD module 203. In yet another embodiment uses a hybrid transmissive-reflective, or transflective, LCD module.

FIGS. 2C and 2D illustrate mirror mode for two different embodiments of mirrored display 102. In both embodiments, viewer 201 sees a reflection of himself in image 202, and the data displayed by LCD module 203 is not visible. In the embodiment of FIG. 2C, the image is formed by a reflection off the surface in front of LCD module 203. In the embodiment of FIG. 2D, the image is formed by light passing through LCD module 203, but LCD module 203 is in a substantially transparent state.

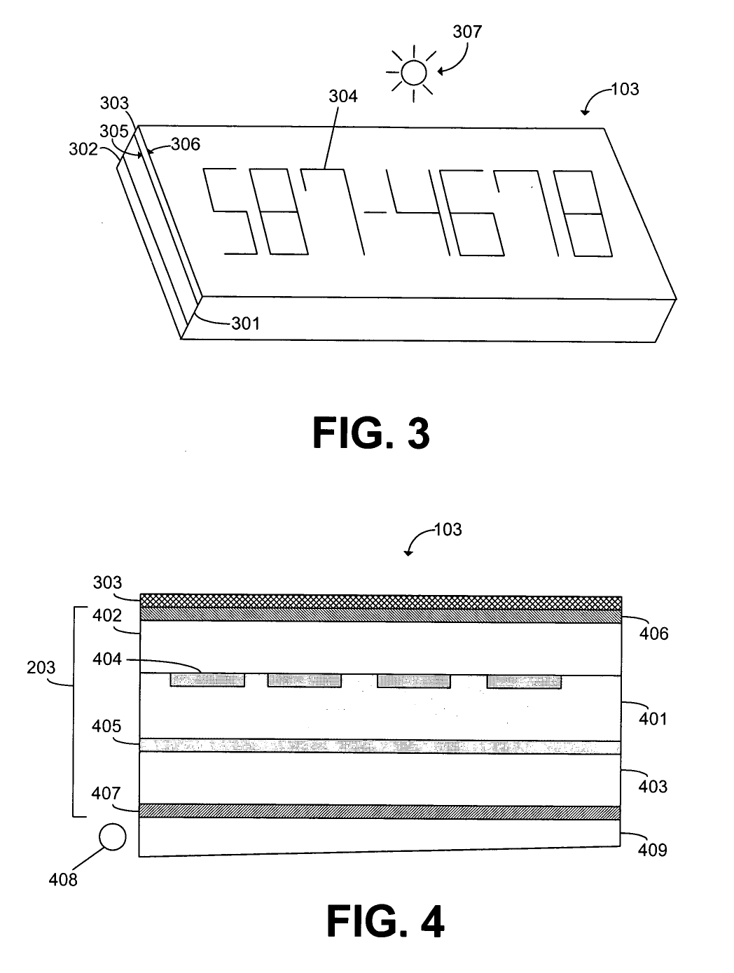

FIG. 3 is a perspective view of mirrored display 102, using the transmissive LCD embodiment of FIG. 2C. Mirrored display 102 combines an LCD module 301, a backlight 302, and a half-mirror 303. Segments 304 within LCD module 203 become opaque when activated by an electric current. When illuminated from one side by backlight 302, segments 304 appear dark against a light background. LCD module 203 can also be described as an electro-optical means having optical properties that vary according to electric current: the cell is transparent in a first switching state and opaque in a second switching state. In another embodiment, segments 304 become transparent when electric current is applied and are opaque otherwise. In other embodiments LCD module 203 can be replaced by other types of electro-optical means such as nematic gels (polymer gel in which the solvent is a nematic liquid crystal), and polymer dispersed liquid crystals.

Half-mirror 303 is partially transparent and partially reflective: light incident on transparent side 305 is transmitted, while light incident on the reflective side 306 is reflected. Thus, half-mirror 303 acts as both window and a mirror. Which one dominates depends on the intensity of ambient light 307 incident upon the display front surface compared to the intensity of light produced by backlight 302. Therefore, the intensity of backlight 302 is matched to the reflectance and transmittance characteristics of half-mirror 303.

Backlight 302 is configured so that at full intensity, the transmittance characteristics dominate and half-mirror 303 acts as a window. Through this window, opaque segments 304 are visible against a light background of LCD module 203. When backlight 302 is off, the reflective characteristics of half-mirror 303 are dominant and LCD module 203 is not visible. Instead, the user of the phone 100 can see his reflection mirrored display 102. When the intensity of backlight 302 is between minimum and maximum, LCD module 203 is visible, but reflections off the half-mirror 303 are also visible.

The characteristics of half-mirror 303 can be described by two variables: T, light transmittance through the mirror in either direction; and Rₘ, reflectance on the reflective side 306. The intensity of the reflected image seen by the viewer is Iₘ×Rₘ, while the intensity of the LCD image is Iₜ×T. Thus, in order for the LCD module 203 to be 13 times brighter than the reflective image, a half-mirror with T=0.8, and Rₘ=0.7 needs 15 times more light on the transparent side 305 than on the reflective side 306:

$$13 = \frac{{I}_{t} ⨯ T}{{I}_{m} ⨯ {R}_{m}} ;$$

$$13 = \frac{{I}_{t} ⨯ 0.8}{{I}_{m} ⨯ 0.7} ;$$

$$13 ⨯ 1.13 = \frac{{I}_{t}}{{I}_{m}} ;$$

$$14.9 = \frac{{I}_{t}}{{I}_{m}}$$

Using this information, backlight 302 and half-mirror 303 can be matched appropriately for various viewing scenarios. Because the half-mirror is only partially transmissive, a relatively large value of T is desirable for the half-mirror 303. With a ratio Iₘ:Iₜ of at least 5, it appears that the viewer sees the LCD module 203 without being distracted by the reflected image. At a lower ratio, the reflected image begins to interfere. Higher ratios are desirable but require a proportional increase in the amount of light produced by the backlight 302. Note that Iₜ is a measure of light exiting LCD module 203 rather than the intensity of the backlight itself, as Iₜ takes into account the absorptive and reflective characteristics of the LCD module 203 itself. Nonetheless, for a given LCD module 203 design, there is a direct relationship between the intensity of light produced by backlight 302 and the intensity of light exiting LCD module 203. Thus, it is sometimes convenient to speak of configuring backlight 302, knowing that the characteristics of LCD module 203 must also be taken into account.

FIG. 4 is a side view of the internal structure of mirrored display 102. A liquid crystal material 401 is enclosed between two transparent layers 402 and 403, usually glass or plastic. Various types of liquid crystals can be used, for example, twisted nematic and super-twisted nematic.

Liquid crystal material 401 is in contact with electrodes 404, 405 on the inner surface of transparent layers 402, 403. The electrodes 404 and 405 may take many forms, depending on the type of display. For example, in the segmented display of FIG. 3, one electrode typically covers the surface of one transparent layer, while the other electrode consists of multiple portions applied to segments of the other transparent layer. This arrangement forms the alphanumeric display of FIG. 3.

In a pixel display, one transparent surface has columns of electrodes and the other transparent surface has rows of electrodes, forming pixels at the intersections of the rows and columns. These pixels are activated and become opaque when an electric current is applied between the electrode 404 on one surface 402 and the electrode 405 on the other surface 403. The pixels are typically implemented in conjunction with a Thin Film Transistor (TFT), which separates control of current through the electrodes to be separate from the electrodes themselves. A variation of TFT LCD called in-plane switching (IPS) mounts both electrodes parallel to each other on the same transparent layer. Pixel displays using TFT are also called active matrix displays. Another type of pixel display called passive matrix is also known. The invention applies to both active and passive matrix, as well as segmented LCD modules.

A polarizer is applied on the other side of each transparent layer, opposite the liquid crystal material 401. Other layers with various optical properties may also be applied between the transparent layer and the polarizer, for example, a retardation layer or a scattering layer. The orientation axis of polarizer 406, on transparent layer 402, is different than the axis of polarizer 407, on transparent layer 403. It is this difference in orientation that causes portions of liquid crystal material 401 to appear opaque when an electric current is applied.

Light enters LCD module 203 from below, passing first through polarizer 407, which polarizes the light in a first direction. When no electric current is applied, the optical properties of liquid crystal material 401 cause the light to be polarized in a second direction. This second direction matches the orientation of polarizer 406, so the light passes through polarizer 406. Thus, the viewer sees LCD module 203 as a light background.

However, when electric current is applied, the optical properties of liquid crystal material 401 do not polarize the light in a second direction. Therefore, the light does not pass through polarizer 406. Those portions of LCD module 203 where the current was applied are seen by a viewer as opaque, with the remaining background portions appearing as the light background.

In she example of FIG. 4, backlight 302 comprises an LED 408 mounted to one side of the LCD module 203, and a light guide 409 which disperses the light in a uniform matter along the outside surface of polarizer 407. However, other lighting arrangements are possible, as long as the light enters LCD module 203 on the side opposite half-mirror 303.

The LCD module 203 of FIG. 4 appears to the view as black and white, with shades of gray. However, the invention is also applicable to color LCDs. One type of color LCD uses color filters mounted between the liquid crystal material and the polarizer. Another type of color LCD, called guest-host, incorporates an anisotropic dye into the liquid crystal material. The electric current reorients the dye molecules as well as the liquid crystals, and the dye molecules switch between transparent and opaque states.

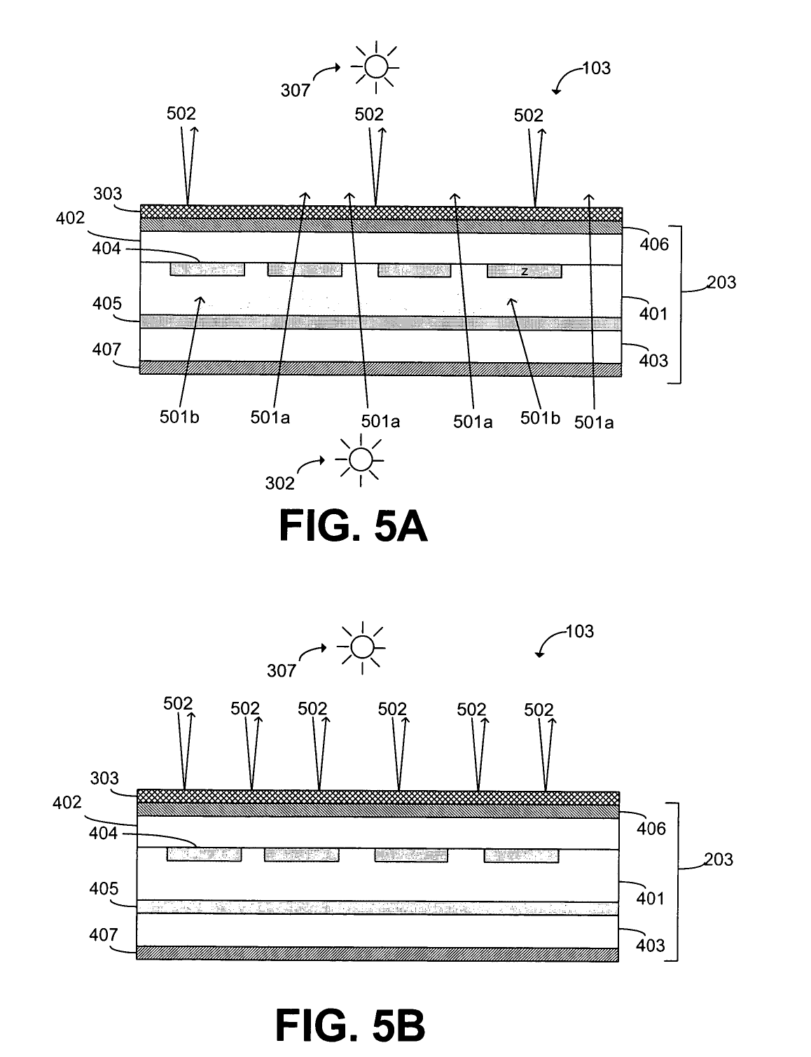

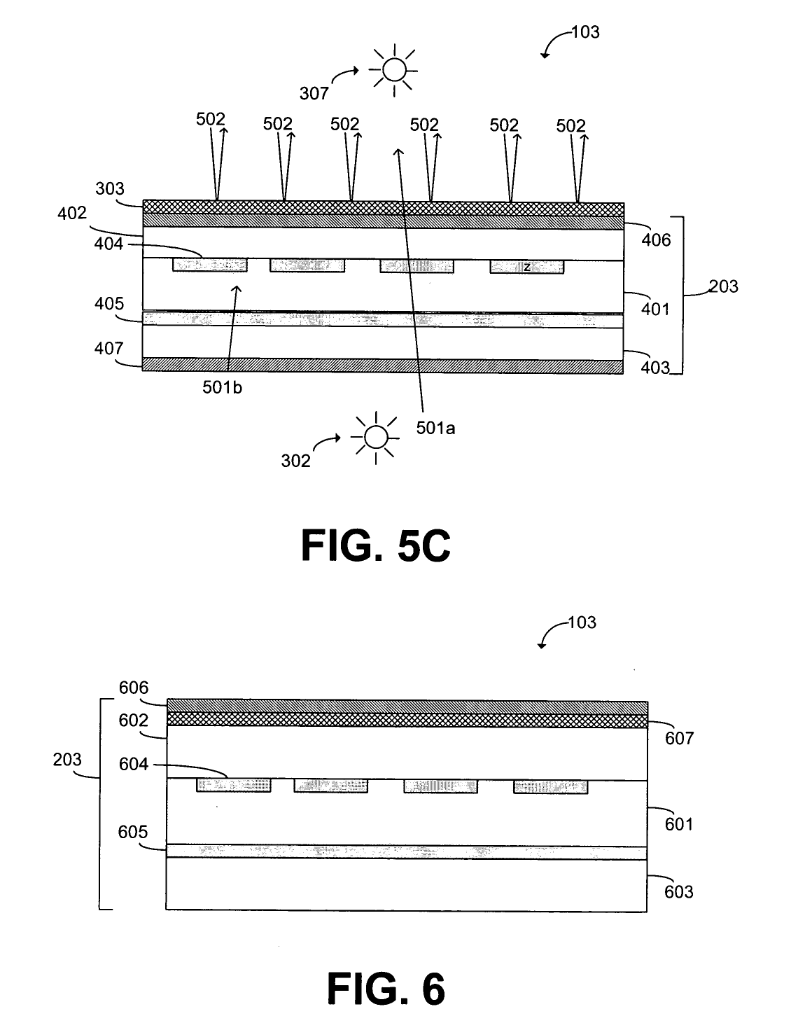

FIG. 5A is a side view of the internal structure of mirrored display 102 showing how the display appears to the user when light from backlight 302 is at a maximum. In this simplified view, the structure of backlight 302 is not shown. In this scenario, rays 501 produced by backlight 302 dominate the rays 502 produced by ambient light 503 (e.g., room lighting). Rays 501a pass through regions of liquid crystal material 401 which do not have electric current. The optical properties of liquid crystal material 401 allow these rays to exit LCD module 203, where they hit the transmissive transparent side 305 of half-mirror 303. The transmissive surface of half-mirror 303 allows all of these rays 501a to exit half-mirror 303, so that the viewer sees these regions of LCD module 203 as a light-colored background.

Other rays 501b produced by backlight 302 pass through regions of liquid crystal material 401 which have an electric current flow. The optical properties of liquid crystal material 401 do not allow these rays to exit LCD module 203, so that these regions of LCD module 203 appear dark to the viewer.

In this scenario, ambient light 307 produces some rays 502. These rays 502 are reflected off the reflective side of half-mirror 303, without entering LCD module 203. Thus, the viewer may see a slight reflection off the display, but the overall effect of half-mirror 303 is as a window into LCD module 203 because the light output from backlight 302 dominates ambient light 503.

FIG. 5B is a side view of the internal structure of mirrored display 102 showing how the display appears to the user when backlight 302 is off. In this scenario, only rays 502 produced by ambient light 503 illuminate the mirrored display 102. These rays 502 are reflected off the reflective reflective side 306 of half-mirror 303, without entering LCD module 203. Thus, the viewer sees only a reflection, and LCD module 203 is not visible.

FIG. 5C is a side view of the internal structure of mirrored display 102 showing how the display appears to the user when backlight 302 produces a minimal amount of light. In this scenario, the mirrored display 102 is illuminated by rays 502 produced by ambient light 503 and by rays produced by backlight 302. However, rays 502 produced by ambient light 503 dominate. Therefore, the viewer sees a reflection off half-mirror 303 with LCD module 203 faintly visible behind the mirror.

FIG. 6 is a perspective view of mirrored display 102, using the reflective LCD embodiment of FIGS. 2A and 2D. In this embodiment, LCD module 203 can be switched to a substantially transparent state, so that light passes through LCD module 203 and is then reflected off a reflective surface. LCD module 203 comprises: liquid crystal material 601; two transparent layers 602 and 603 enclosing the liquid crystal material; top electrode 604 and bottom reflective electrode 605; polarizer 606; and retarder 607.

Light entering LCD module 203 first passes through linear polarizer 606, and then retarder 607. The result is light that is circularly polarized in a first direction. After passing through liquid crystal material 601, light hits reflective electrode 605, where it becomes circularly polarized in the opposite direction. In areas of LCD module 203 with no current flow, LCD module 203 is substantially transparent, so the light passes through LCD module 203 and enters retarder 607. The second pass through retarder 607 results in linearly polarized light which exits through polarizer 606. In areas of LCD module 203 with current flow, the light does not passes through LCD module 203, so these areas are seen by the viewer as opaque.

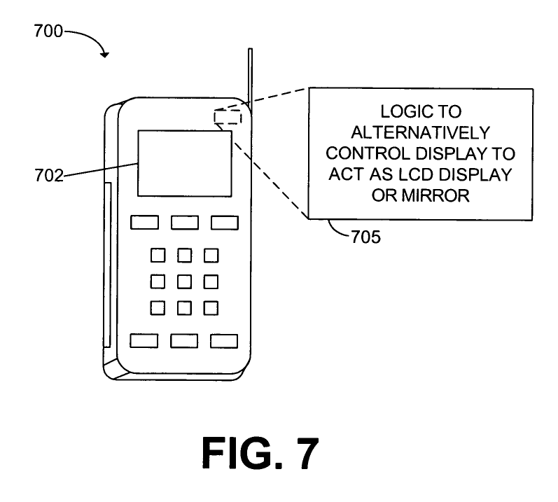

FIG. 7 is a diagram illustrating components of an embodiment of the invention. As shown, in this embodiment, a telephone 700 comprises an LCD display 702 and logic 705 that is configured to selectively operate the display 702 as a conventional LCD display and a mirror. As described herein, the LCD may include a reflective rear surface, so that when the LCD is controlled to allow light to pass through the overlying layers, light is reflected off the rear surface, thereby configuring the LCD to effectively function as a mirror. At other times, the LCD may be controlled to operate in a conventional manner, displaying numbers, characters, and other information to a use. The selectivity of the display 702 may be in response to a key that they user can depress to activate.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen, and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

1. A wireless telephone comprising:
communication logic configured to send and receive signals from a base station over a wireless channel, the base station in communication with a telephone network;
a mirrored liquid crystal display comprising:
a liquid crystal module;
a half-mirror layer, which is partially reflective and partially transmissive, affixed to one surface of the liquid crystal module;
a backlight producing light directed at an opposite surface of the liquid crystal module,
wherein the intensity of light produced by the backlight is matched to the reflective and transmissive characteristics of the half-mirror layer such that when the light output is at a minimum, the half-mirror layer is substantially reflective and the liquid crystal module is substantially invisible, and when the light output is at a maximum, the half-mirror layer is substantially transmissive and the liquid crystal module is substantially visible; and
input logic configured to receive input from the user to control the communication logic and to control the intensity of the light produced by the backlight.

2. The apparatus of claim 1, wherein the half-mirror layer comprises:
a reflective surface with reflectance value Rₘ; and
a transparent surface with reflectance value Rₜ,
wherein the half-mirror layer has a light transmittance value T, and wherein T, Rₘ and Rₜ are chosen so that the ratio Iₜ:Iₘ is at least 5, wherein Iₘ is the intensity of an image reflected off the half-mirror layer and Iₜ is the intensity of light exiting the LCD display.

3. The apparatus of claim 1, wherein the half-mirror layer comprises:
a reflective surface with reflectance value Rₘ; and
a transparent surface with reflectance value Rₜ,
wherein the half-mirror layer has a light transmittance value T, and wherein T, Rₘ and Rₜ are chosen so that the ratio Iₜ:Iₘ is at least 5, wherein Iₘ is the intensity of an image reflected off the half-mirror layer and Iₜ is the intensity of light exiting the LCD display.

4. The apparatus of claim 1, wherein the liquid crystal module comprises:
a first and second transparent layer facing each other;
a first electrode affixed to inner surface of first transparent layer;
a second transparent layer affixed to inner surface of second transparent layer;
a liquid crystal material sealed between the first and second transparent layers;
a first polarizing layer affixed to outer surface of first transparent layer having a first polarization axis; and
a second polarizing layer affixed to outer surface of second transparent layer having a second polarization axis different than the first polarization axis.

5. The apparatus of claim 3, wherein the first and second electrodes are transparent.

6. The apparatus of claim 3, wherein the liquid crystal material is chosen from the group of twisted nematic or super-twisted nematic.

7. The apparatus of claim 3, wherein the second polarization axis is rotated 90° from the first polarization axis.

8. The apparatus of claim 1, wherein the LCD module further comprises a color filter.

9. The apparatus of claim 1, wherein the input logic is further configured to enable and disable the backlight. A wireless telephone comprising:
communication logic configure to send and receive signals from a base station over a wireless channel, the base station in communication with a telephone network;
a mirrored liquid crystal display comprising:
an electro-optical means;
a means for partially reflecting and partially transmitting light rays, affixed to one surface of the electro-optical means;
a means for producing light directed at an opposite surface of the electro-optical optical means
wherein the intensity of light produced by the backlight is matched to the reflective and transmissive characteristics of the means for partially reflecting and partially transmitting, such that when the light output is at a minimum, the means for partially reflecting and partially transmitting is substantially reflective and the electro-optical means is substantially invisible, and when the light output is at a maximum, the means for partially reflecting and partially transmitting is substantially transmissive and the electro-optical means is substantially visible; and
input logic configured to receive input from the user to control the communication logic and to control the intensity of the light produced by the means for producing light.

10. The apparatus of claim 10, wherein the means for partially reflecting and partially transmitting comprises:
a reflective surface with reflectance value Rₘ; and
a transparent surface with reflectance value Rₜ,
wherein the half-mirror layer has a light transmittance value T, and wherein T, Rₘ and Rₜ are chosen so that the ratio Iₜ:Iₘ is at least 5, wherein Iₘ is the intensity of an image reflected off the half-mirror layer and Iₜ is the intensity of light exiting the LCD display.

11. The apparatus of claim 10, wherein the electro-optical means comprises an LCD module.

12. The apparatus of claim 10, wherein the electro-optical means comprises:
a first and second transparent layer facing each other;
a first electrode affixed to inner surface of first transparent layer;
a second transparent layer affixed to inner surface of second transparent layer;
a liquid crystal material sealed between the first and second transparent layers;
a first polarizing layer affixed to outer surface of first transparent layer having a first polarization axis; and
a second polarizing layer affixed to outer surface of second transparent layer having a second polarization axis different than the first polarization axis.

13. The apparatus of claim 13, wherein the first and second electrodes are transparent.

14. The apparatus of claim 13, wherein the second polarization axis is rotated 90° from the first polarization axis.

15. The apparatus of claim 11, wherein the LCD module further comprises a color filter.

16. The apparatus of claim 11, wherein the input logic is further configured to enable and disable the backlight. A telephone comprising:
a liquid crystal display (LCD); and
logic for controlling the LCD to selectively operate in one of two alternative states, including a first state in which the LCD operates in a conventional manner to display visible data to a user, and a second state in which the LCD effectively functions as a mirror.

17. The telephone of claim 18 further including a reflective coating coupled to a rear side of the LCD, and wherein the LCD further includes a layer interposed between the reflective coating and the outside of the LCD, whereby when the LCD is configured in the second state the transmissive characteristics of the layer are controlled so an outside image is reflected from the reflective layer.

18. A telephone comprising:
a liquid crystal display (LCD); and
logic for controlling the LCD to selectively function as a mirror.

19. The telephone of claim 18 filer including a reflective coating coupled to a rear side of the LCD, and wherein the LCD further includes a layer interposed between the reflective coating and the outside of the LCD, whereby when the LCD is configured in the second state the transmissive characteristics of the layer are controlled so an outside image is reflected from the reflective layer.

20. A telephone comprising:
a liquid crystal display (LCD); and
logic for controlling the LCD to selectively function as a mirror.
